(19) United States
(12) Patent Application Publication
(10) Pub. No.: US 2023/0338121 A1
(43) Pub. Date: Oct. 26, 2023

(54) CAMERA-BASED GUIDANCE OF DENTAL INSTRUMENTS

(71) Applicant: DENTSPLY SIRONA Inc., York, PA (US)

(72) Inventors: Jörg Witthaus, Bensheim (DE); Björn Voss, Einhausen (DE)

(73) Assignee: DENTSPLY SIRONA Inc., York, PA (US)

(21) Appl. No.: 17/724,780

(22) Filed: Apr. 20, 2022

(51) Int. Cl. A61C 9/00; A61C 7/00; A61C 19/04

(52) U.S. Cl. CPC A61C 9/0053; A61C 7/002; A61C 19/04

(57) ABSTRACT

Capturing obscured areas in an oral cavity of a patient by providing a dental instrument with a camera to capture at least an area of operation of the dental instrument and comparing two-dimensional (2D) images from the camera with a three-dimensional (3D) model of the patient's jaw to compute a position of the camera or dental instrument in relation to the patient's jaw. Information about a deviation of one or more actual dental process parameters from one or more corresponding planned dental process parameters are displayed.

### TECHNICAL FIELD

The invention relates generally to a camera-based guidance of dental instruments and more specifically to a method and system for guiding the operation of dental instruments in a dental workflow based on a camera configured to capture areas of a jaw that are invisible or poorly visible to the user.

### BACKGROUND

Presently, technology exists to drill and install dental implants in a dental surgery procedure. Dental surgery may replace tooth roots with metal, screwlike posts and may replace damaged or missing teeth with artificial teeth or restorations. The dental surgery process may depend on the type of implant and the condition of the jawbone and may involve several procedures.

### SUMMARY

In an aspect, a camera-based guidance method is disclosed. The method may comprise providing a dental instrument, providing a camera fixedly attached to or integrated into the dental instrument, capturing, by the camera, invisible or poorly visible areas in an oral cavity of a patient by configuring the camera to capture at least an area of operation of a drill of the dental instrument, comparing two dimensional (2D) images from the camera with an existing three-dimensional (3D) model of the patient's jaw to compute a position of the camera or dental instrument in relation to the patient's jaw, computing a positional relationship between the drill of the dental instrument and the jaw based at least in part on the computed position of the camera or dental instrument, and computing and displaying information about a deviation of one or more actual drilling parameters from one or more corresponding planned drilling parameters to aid a user during drilling. The comparing step may be based at least in part on matching at least one characteristic feature of teeth present in at least one of the 2D images with a corresponding characteristic feature present in the textured 3D model and the matching may be performed at runtime based on a search for a sufficient correspondence of said at least one of the 2D images and the 3D model. Responsive to obtaining the correspondence that allows a clear assignment of said at least one of the 2D images to a jaw region, the positional relationship between the drill of the dental instrument and the jaw may be computed as discussed hereinafter. The assignment may be performed by computing a projection of the 3D model that corresponds to said at least one of the 2D images. For this purpose, a projection of the 3D model that most closely corresponds to the 2D image may be calculated for each individual image of the 2D camera in an optimization process. The optimization process may maximize the similarity between the projection of the 3D model and the 2D image and a homography may be obtained. The method may also further include determining an angle of view, orientation, or distance measure of the camera as a camera measurement value based on said homography. The method may also include further include determining said positional relationship between the drill of the dental instrument and the jaw based at least in part on said camera measurement value. The method may also include determining said positional relationship between the drill of the dental instrument and the jaw based at least in part on dimensions of components of the dental instrument and the camera (i.e. a fixed relation between the drill and the camera, for example). The method may also include computing the at least one characteristic feature on the 3D model and on the 2D images prior to the matching. The method may also include creating a live or a non-real time feature database that includes the at least one characteristic feature for said matching. The method may also include filtering the live or non-real time feature database to reduce a number of available characteristic features.

In one aspect, a computer system may be disclosed that comprises at least one processor configured to perform the one or more of the processes described herein. In another aspect, a non-transitory computer-readable storage medium storing a program which, when executed by a computer system, causes the computer system to perform one or more of the processes described herein is disclosed.

In a further aspect, a system is disclosed that comprises a dental instrument with a drill, a camera fixedly attached to or integrated into the dental instrument and configured to capture invisible or poorly visible areas of the areas in an oral cavity, and a screen configured to display the captured invisible or poorly visible areas of the areas in an oral cavity. The screen may further be configured to display a deviation of one or more actual drilling parameters from one or more corresponding planned drilling parameters to aid a user during drilling.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a block diagram of a data processing environment in which illustrative embodiments may be implemented.

FIG. 2 depicts a block diagram of a data processing system in which illustrative embodiments may be implemented.

FIG. 3 depicts a side view of a dental instrument in accordance with illustrative embodiments.

FIG. 4 depicts a side view of a dental instrument in accordance with illustrative embodiments.

FIG. 5 depicts a side view of a head of a dental instrument in accordance with illustrative embodiments.

FIG. 6 depicts a top view of a head of a dental instrument in accordance with illustrative embodiments.

FIG. 7 depicts a side view of a dental instrument in accordance with illustrative embodiments.

FIG. 8 depicts a side view of a dental instrument in accordance with illustrative embodiments.

FIG. 9 depicts a side view of a dental instrument in accordance with illustrative embodiments.

FIG. 10 depicts a process in accordance with illustrative embodiments.

FIG. 11 illustrates an aspect of the subject matter in accordance with one embodiment.

### DETAILED DESCRIPTION

The illustrative embodiments recognize that the view into the patient's month may be restricted and a practitioner's view when preparing cavities may be obscured by the drill head. Drilling into the jawbone during implantology may be performed without a guide. Under certain circumstances, drill holes may be drilled at the wrong angle or to the wrong depth. Drilling may then have to be carried out several times and the structure of the jawbone may be unnecessarily damaged. In some case, the jawbone may be damaged to such an extent that it may not be possible to place the implant. The illustrative embodiments recognize that drilling in the direct vicinity of a nerve in the jaw can lead to a permanent sensation of pain. Likewise, the jaw nerve may be irreversibly damaged. Guiding the user with technical aids may reduce the likelihood of patient injury due to incorrectly placed implant holes.

The illustrative embodiments used to describe the invention generally disclose methods and systems of guiding a dental process by computing and displaying information about a deviation of one or more actual drilling parameters from one or more corresponding planned drilling parameters to aid a user during drilling.

In one aspect, a method includes providing a dental instrument, providing a camera fixedly attached to or integrated into the dental instrument, capturing, by the camera, invisible or poorly visible areas in an oral cavity of a patient by configuring the camera to capture at least an area of operation of a drill of the dental instrument, comparing two dimensional (2D) images from the camera with an existing three-dimensional (3D) model of the patient's jaw to compute a position of the camera or dental instrument in relation to the patient's jaw, computing a positional relationship between the drill of the dental instrument and the jaw based at least in part on the computed position of the camera or dental instrument, and computing and displaying information about a deviation of one or more actual drilling parameters from one or more corresponding planned drilling parameters to aid a user during drilling.

In another aspect, a system is disclosed. The system may comprise a dental instrument which includes a drill, a camera fixedly attached to or integrated into the dental instrument and configured to capture invisible or poorly visible areas of the areas in an oral cavity and a screen configured to display the captured invisible or poorly visible areas of the areas in an oral cavity, wherein the screen is further configured to display a deviation of one or more actual drilling parameters from one or more corresponding planned drilling parameters to aid a user during drilling.

These examples of methods and systems and the like are not intended to be limiting. From this disclosure, those of ordinary skill in the art will be able to conceive many other aspects applicable towards a similar purpose, and the same are contemplated within the scope of the illustrative embodiments.

The illustrative embodiments are described with respect to certain types of data, functions, algorithms, equations, model configurations, locations of embodiments, additional data, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other dental system, structures, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

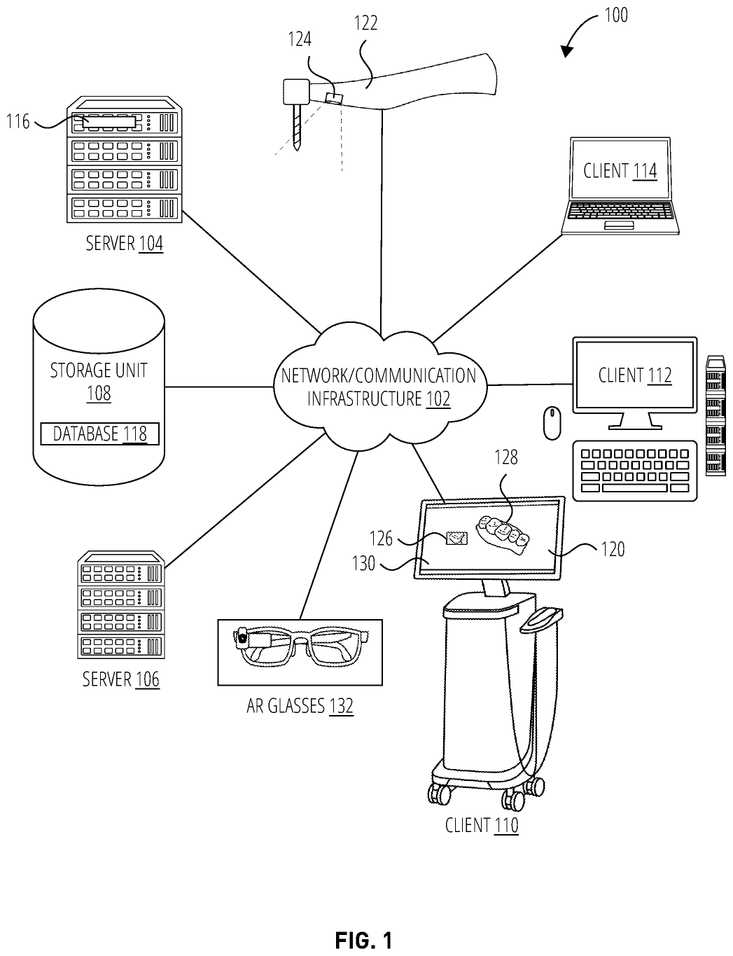

With reference to the figures and in particular with reference to FIG. 1 an example diagram of a data processing environment in which illustrative embodiments may be implemented is shown. FIG. 1 is only an example and is not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment is a network of computers in which the illustrative embodiments may be implemented. Data processing environment 100 includes network/communication infrastructure 102. Network/communication infrastructure 102 is the medium used to provide communication links between various devices, databases and computers connected together within data processing environment 100. Network/communication infrastructure 102 may include connections, such as wire, wireless communication links, or fiber optic cables.

Clients or servers are only example roles of certain data processing systems connected to network/communication infrastructure 102 and are not intended to exclude other configurations or roles for these data processing systems. Server 104 and server 106 couple to network/communication infrastructure 102 along with storage unit 108. Software applications may execute on any computer in data processing environment 100. Client 110, client 112, client 114 are also coupled to network/communication infrastructure 102. Client 110 may be a dental acquisition unit with a display. A data processing system, such as server 104 or server 106, or clients (client 110, client 112, client 114) may contain data and may have software applications or software tools executing thereon.

Only as an example, and without implying any limitation to such architecture, FIG. 1 depicts certain components that are usable in an example implementation of an embodiment. For example, servers and clients are only examples and do not to imply a limitation to a client-server architecture. As another example, an embodiment can be distributed across several data processing systems and a data network as shown, whereas another embodiment can be implemented on a single data processing system within the scope of the illustrative embodiments. Data processing systems (server 104, server 106, client 110, client 112, client 114) also represent example nodes in a cluster, partitions, and other configurations suitable for implementing an embodiment.

Dental instrument 122 may include a drill 306 that may be used to drill into a patient's jaw. A camera 124 attached to the dental instrument may provide an unobstructed view of a jaw for a dental procedure. In an example, the camera 124 captures two-dimensional (2D) images each of which may be matched with a corresponding projection of a 3D model. This may enable a user to obtain a largest possible field of view of the jaw. Based on similarities between the projections and the 2D images, a homography, or a similar perspective transformation model (linear transformation that transforms 3 dimensional objects on a two dimensional picture plane), may be obtained and may be used to compute an angle of view, orientation, and distance measure of the camera for guiding a dental procedure.

Client application 120 or any other application 116 implements an embodiment described herein. Client application 120 can use data from camera 124, dental instrument 122 and/or other devices to generate guidance proposals.

Client application 120 can also execute in any of data processing systems (server 104 or server 106, client 110, client 112, client 114), such as client application 116 in server 104 and need not execute in the same system as client 110.

Server 104, server 106, storage unit 108, client 110, client 112, client 114, may couple to network/communication infrastructure 102 using wired connections, wireless communication protocols, or other suitable data connectivity. Client 110, client 112 and client 114 may be, for example, personal computers or network computers.

In the depicted example, server 104 may provide data, such as boot files, operating system images, and applications to client 110, client 112, and client 114. Client 110, client 112 and client 114 may be clients to server 104 in this example. Client 110, client 112 and client 114 or some combination thereof, may include their own data, boot files, operating system images, and applications. Data processing environment 100 may include additional servers, clients, and other devices that are not shown. Server 104 includes an application 116 that may be configured to implement one or more of the functions described herein for displaying a live control view in accordance with one or more embodiments.

Server 106 may include a search engine configured to search stored files such as images, 3D models of patients and preferences for a dental practice in response to a request from an operator as described herein with respect to various embodiments.

In the depicted example, data processing environment 100 may be the Internet. Network/communication infrastructure 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of dental practices, commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

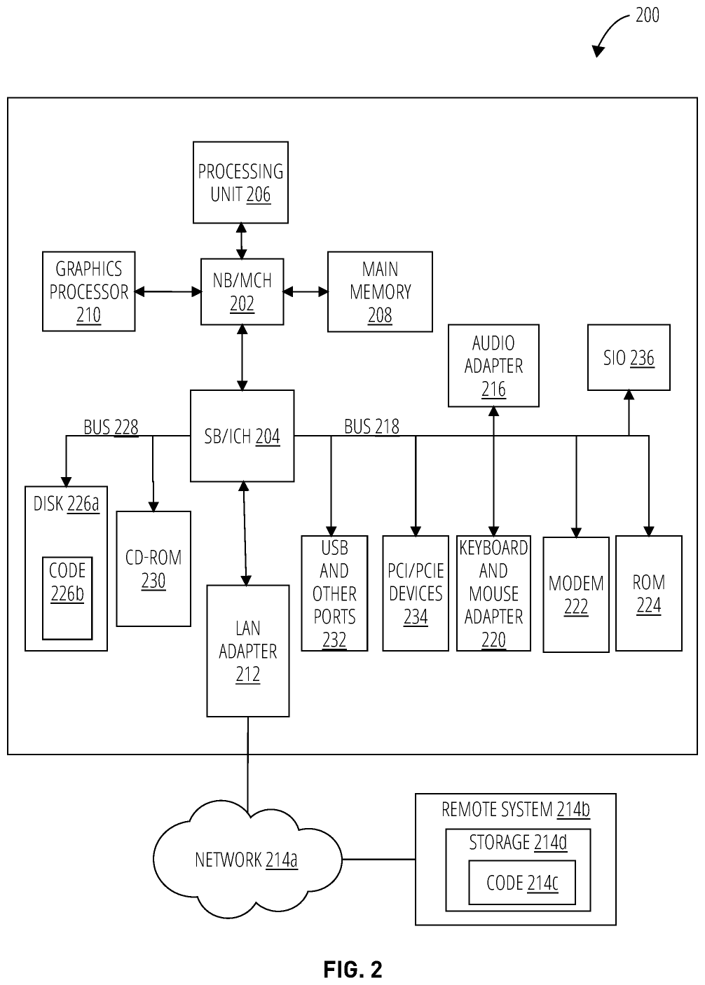

With reference to FIG. 2, this figure depicts a block diagram of a data processing system in which illustrative embodiments may be implemented. Data processing system 200 is an example of a computer, such client 110, client 112, client 114, server 104, server 106, in FIG. 1, or another type of device in which computer usable program code or instructions implementing the processes may be located for the illustrative embodiments.

Data processing system 200 is described as a computer only as an example, without being limited thereto. Implementations in the form of other devices, in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SBICH) 204 through bus 228. PCI/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as server application 116 and client application 120 in FIG. 1, are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 1 and FIG. 2 may vary depending on the implementation. Other internal hardware or peripheral devices, such as flash memory, equivalent non-volatile memory, or optical disk drives and the like, may be used in addition to or in place of the hardware depicted in FIG. 1 and FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 1 and FIG. 2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and Hard disk drive (HDD) or solid-state drive (SSD) 226a is manifested as a virtualized instance of all or some portion of Hard disk drive (HDD) or solid-state drive (SSD) 226a that may be available in the host data processing system. The host data processing system in such cases is represented by data processing system 200.

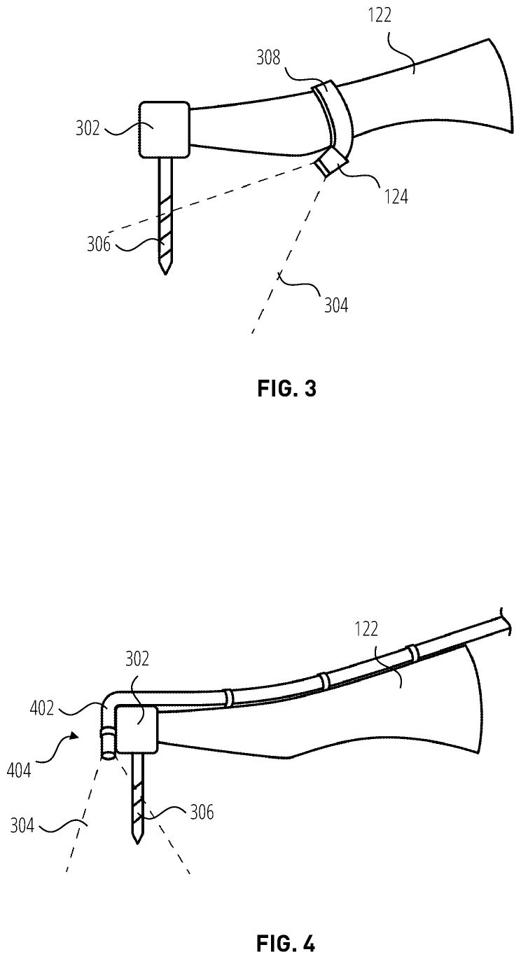

Turning now to FIG. 3, a diagram of a dental instrument 122 is shown. The dental instrument 122 may comprise a drill 306, a drill head 302, and a camera 124 fixedly attached to or integrated into the dental instrument 122 and configured to capture areas of the oral cavity that are obstructed from a user's view. This may be based on a positioning of the camera 124 such that a field of view 304 of the camera includes the obstructed areas. A screen 130 may be configured to display the obstructed areas of the areas in an oral cavity, with the screen being further configured to display a deviation of one or more actual drilling parameters from one or more corresponding planned drilling parameters to aid a user during drilling. The screen 130 may be configured as a monitor or alternatively as a pair of augmented reality glasses (AR glasses 132). The dental instrument 122 and screen may form part of a system having a processor configured to compare two-dimensional (2D) images from the camera 124 with an existing three-dimensional (3D) model of the patient's jaw to compute a position of the camera 124 or dental instrument 122 in relation to the patient's jaw. The system may compute a positional relationship between the drill of the dental instrument and the jaw based at least in part on the computed position of the camera or dental instrument and may also compute and display information about a deviation of one or more actual drilling parameters from one or more corresponding planned drilling parameters to aid a user during an implant procedure. This may be advantageous due to the ability to fit seamlessly into a digital workflow of implantology. A 3D guided drilling may be performed directly after implant planning, i.e. in an implant planning, a combination of optical 3d geometry of the patients' teeth is combined with 3D X-Ray data to plan the drill channel in the patients jaw. One result of the implant planning is a definition of the location, orientation and depth of the drill hole. A 3D guided drilling could be a visual (and/or acoustic) feedback for example on a screen that helps the dentist to drill at the correct position, in the correct direction/angle and the correct depth. No preparations may be required in terms of attaching external abutments, calibrating sensors and actuators, or making 3D drilling templates and the time saved may benefit both the patient and the dentist. The patient may obtain dentures, artificial teeth or restorations faster and the necessary appointments and the duration of implantology may be reduced. The use of a 2D camera in an embodiment technology may also be beneficial due to low cost of the camera. In one aspect, an extension of an existing system (a 2D camera on an instrument and a display option for the images) may be disclosed. Further, a real-time evaluation algorithm may be disclosed. The real-time evaluation process may compute said positional relationship between a drill and a jaw and may also display the information about the deviation.

In a further aspect, the camera 124 system may be configured as a single use or multiple use camera. In an embodiment having single use camera, the camera may be removed from a sterile package prior to treatment and may be discarded after treatment. In an embodiment having a multiple-use camera, the camera may be sterilized after treatment. For example, a sterilizable endoscope system that is already in use in a clinical field may be used in an embodiment herein. The camera 124 may also be configured as an intraoral 2D camera.

As shown in FIG. 3, the dental instrument 122 may have a slip-on mount 308 for the camera 124, said slip on mount 308 being configured to slip onto the dental instrument 122 and position the camera 124 in a location and angle for a field of view 304 of the camera to capture areas of the jaw or oral cavity obscured by the drill head 302 or a head of the dental instrument.

As shown in FIG. 4, the camera 124 may be an endoscope 402 and may be disposed at a head area 404 of the dental instrument 122. In such a configuration, the field of view 304 may more clearly include an area of the jaw obscured from a user's view by the drill head 302.

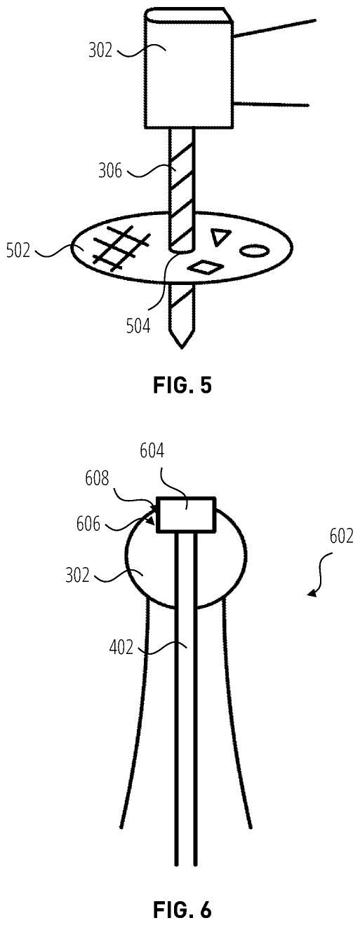

Further, for accurate detection performance, a simple calibration of the camera 124 via a pattern plate 502 comprising a hole 504 for inserting the drill 306 may be performed as shown in FIG. 5. The pattern plate may be a plate with a printed and well-defined pattern. Knowing the pattern allows the computation of intrinsic and extrinsic 2d camera parameters. Moreover, the camera or endoscope may be locked in a fixed position (via, for example, a magnetic lock 608 in a recess 606) on the drill head 302 as shown in the top view of the drill head 602 in FIG. 6. Herein, an immersible endoscope head 604 may be immersed into the recess 606 and may be held in a fixed position, via for example, the magnetic lock 608. The magnetic lock may be realized, for example, via a recess formed according to the key-lock principle, in which the head of the endoscope is locked via magnetic forces.

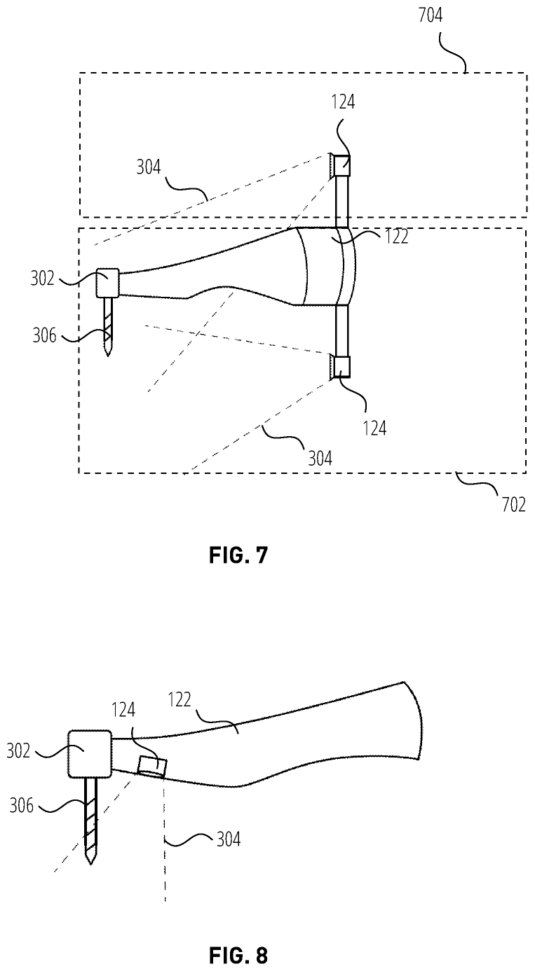

In another aspect, the camera 124 may be disposed outside a first region 702 about the camera 124 that requires sterilization of dental instrument or camera parts inside that first region 702 as shown in FIG. 7. Therefore, the camera may not have to be sterilized after use. Further, prior to use of the dental instrument for a drilling procedure, the camera 124 may be movable from the first region 702 about the camera that requires sterilization of dental instrument or camera parts inside that first region 702 to a second region 704 about the camera that does not require sterilization of dental instrument or camera parts inside that second region 704. An orientation of the camera may also be changeable to ensure capturing of a relevant area of the jaw obscured from an initial field of view of the camera 124.

In alternative embodiments, a plurality of cameras 124 may be attached to or integrated into the dental instrument 122 or camera orientations may be configured to increase the field of view options or areas captured by the cameras for further processing.

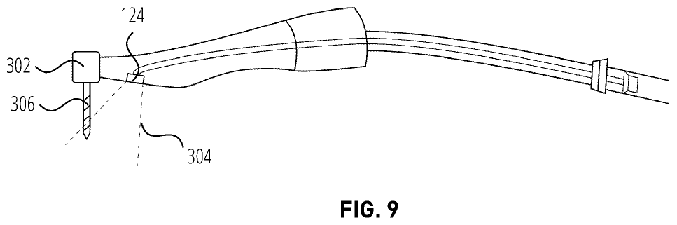

As shown in FIG. 8, the camera 124 may be integrated in the instrument. The camera may thus be sterilized together with the instrument. In another embodiment, as shown in FIG. 9, the camera is an endoscope, for example, and is integrated into a housing of the instrument behind a sterilizable area of the motor and hose. This means that the camera may not have to be sterilized. In one or all embodiments herein, the camera or camera optics may be kept free of contamination and fogging. Contaminants may be removed, for example, by contaminant removing devices as a blower on the instrument or by a wiping mechanism. Fogging of panes may be prevented by heating of the instrument with integrated camera, the external camera or the endoscope. Further, either the component or system may be heated during treatment, or the component or system may be heated before treatment via an external heat source, e.g., a heat source disposed inside the instrument holder (e.g. a holder for drills and other instruments, usually integrated in a dental treatment unit.).

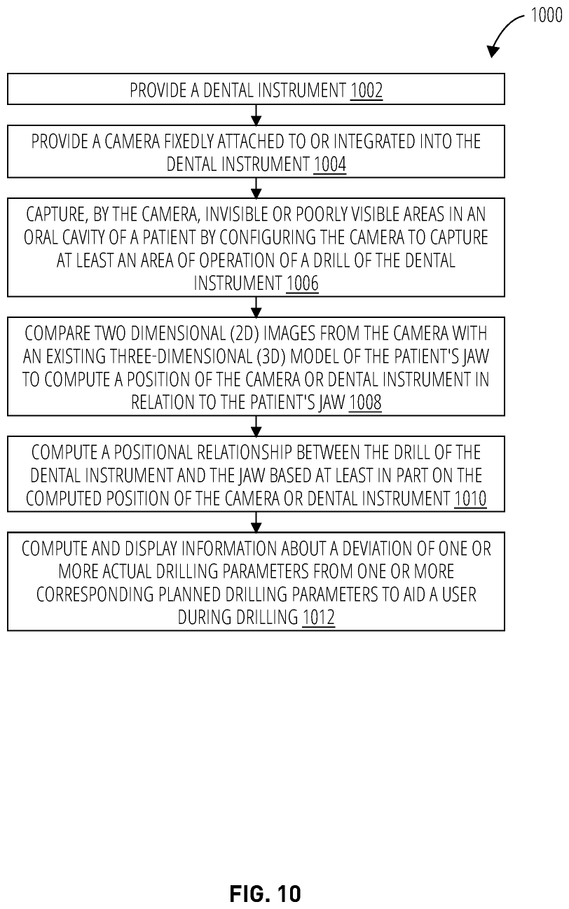

Turning now to FIG. 10, a camera-based guidance process 1000 is disclosed. The process may begin at step 1002, wherein a dental instrument is provided. In step 1004, a camera may be fixedly attached to or integrated into the dental instrument. In step 1006, process 1000 may capture, by the camera, invisible or poorly visible areas in an oral cavity of a patient. The areas may be areas obscured from a user's view by one or more factors including, for example, a drill head 302 of the dental instrument. This may be achieved by configuring the camera to capture at least an area of operation of a drill of the dental instrument. The area of operation may be captured as a series of 2D images. In step 1008, process 1000 may compare the 2D images from the camera with an existing three-dimensional (3D) model of the patient's jaw to compute a position of the camera or dental instrument in relation to the patient's jaw. In step 1010, process 1000 may compute a positional relationship between the drill of the dental instrument and the jaw based at least in part on the computed position of the camera or dental instrument. However, since the camera is fixed to the instrument, the position of the camera (relative to the jaw) may correspond to the position of the drill by taking into consideration a constant translation (fixed distance between camera and drill). In step 1012, process 1000 computes and displays information about a deviation of one or more actual drilling parameters from one or more corresponding planned drilling parameters to aid a user during drilling.

The process 1000 may display the positional relationship of the drill to the jaw without delay as soon as the drill is inserted into the oral cavity. To speed up a live matching (finding a region on the textured 3D model that, corresponds best to the 2D image) of the 2D images 126 with the 3D model 128, a computation of significant/characteristic tooth features appearing on the textured 3D model may optionally be performed offline in advance of the live matching. This may be done automatically by a feature or texture based extraction algorithms (such as a scale-invariant feature transform (SIFT) feature algorithm), color histogram. FAST (Features from Accelerated Segment Test), PCA-SIFT (Principal Component Analysis-SIFT), F-SIFT (fast-SIFT) and SURF (speeded up robust features) or manually. In a SIFT algorithm, for example, keypoints of objects may be extracted from a set of reference images and stored in a database. An object may be recognized in a new image by individually comparing each feature from the new image to this database and finding candidate matching features based on Euclidean distance of their feature vectors. From the full set of matches, subsets of keypoints that agree on the object and its location, scale, and orientation in the new image may be identified to filter out good matches. In a dental application, significant/characteristic tooth features may be, for example, fissures, characteristic discolorations, characteristic geometries on or between teeth, and gingival transitions or otherwise features that allow an identification of one or more tooth. A feature database may be created for the 3D model 128, which may be used for live matching between 2D images 126 from the camera 124 and the 3D model 128. Alternatively, the computation of features in the textured 3D model may also be performed live (for example, via SIFT feature algorithms).

During treatment, the 2D camera 124 may be activated when the instrument is activated. Characteristic features may also be determined in the 2D camera images (for example via SIFT feature algorithms). These may be matched at runtime with the already created or live feature database and a sufficient correspondence (e.g., a match with a 65% confidence level or more, or 75% confidence level of more or a dedicated distance metric etc.) may be searched for. The correspondence may then allow conclusions to be drawn about the corresponding jaw region. The determination of feature correspondences may be sped up and made more robust, by pre-filtering the feature database of the 3D model. Herein, the planned jaw region from digital implant planning may reduce the data sets offline.

If there is a sufficient and unambiguous correspondence that allows a clear assignment of the 2d image to a corresponding region, the calculation of the positional relationship to this region can be performed. For this purpose, a projection of the 3D model that most closely corresponds to the 2D image may be calculated for a plurality or for each individual image of the 2D camera. As a result of this optimization, which maximizes the similarity between the projection of the 3D model and the 2D image, a homography may be obtained. Specifically, for optimization, the input parameter of an affine transformation may be optimized in a way that the similarity between the 2D image and the textured 3D model is maximized. The resulting input parameters may describe the positional relationship between camera and 3D model. More specifically, the optimization may be a second step that happens, once a matching is successful. The optimization may attempt to determine a transformation that makes 2D image and projection of the 3D model as similar as possible (based on a dedicated distance metric). The result of the optimization may be a transformation and the transformation may be used to derive the camera position (relative to the 3D model) which then corresponds to the drill position, since camera and drill are connected mechanically and since the system is calibrated. Further, the homography may be used to determine the angle of view, orientation, and distance of the camera relative to the surface of the textured 3D model. This information can then be used to determine the position and orientation of the drill relative to the jaw. By comparing implant planning parameters and the “actual position” of the drill, user feedback can be determined which supports the dentist during the drilling process with feedback (optical and/or acoustic) (e.g., a visualized target/actual representation on the monitor or AR glasses). Thus, the method may include computing and displaying information about a deviation of one or more actual drilling parameters from one or more corresponding planned drilling parameters to aid a user during drilling. The one or more corresponding planned drilling parameters may include parameters such as a drilling angle and a drilling depth.

Thus, in an embodiment, the method may include performing a comparison, based at least in part on matching at least one characteristic feature of teeth present in at least one of the 2D images with a corresponding characteristic feature present in the 3D model, wherein the matching is performed at runtime based on a search of the contents of a correspondence of said at least one of the 2D images and the 3D model.

In the embodiment, the captured poorly visible or obscured areas of the oral cavity may be displayed. Further, the computed position of the drill in relation to the patient's jaw may also be displayed. Even further, the camera 124 may have a light source configured to provide light to brighten features of the jaw for capture.

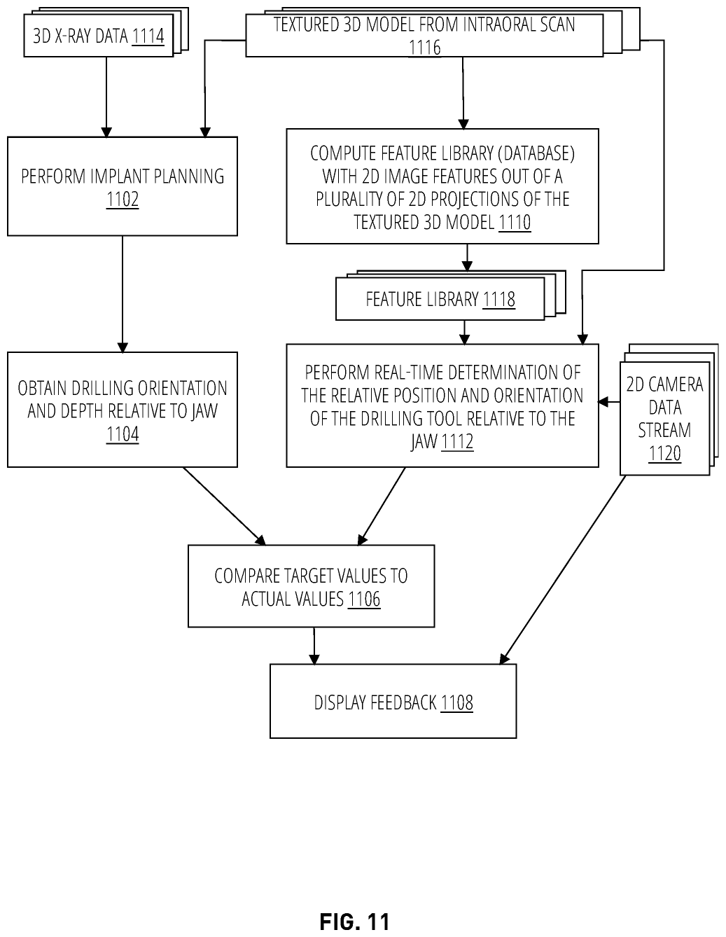

In a further example of a process herein, as shown in FIG. 11, a digital volume tomography (DVT) or 3D X-Ray Data 1114 of a patient's jaw may be taken. A 3D model 1116 of the jaw may also be obtained using an optical camera. The digital DVT and 3D optical model may be merged to obtain a combined image that shows a position of the alveolar nerve. An implant planning application may then be used to plan in step 1102 a virtual denture or restoration and implant. An elongation of the implant towards the occlusal plane may also be computed to illustrate the emergence profile. Measurements may be carried out without further calibration. An automatic determination of the orientation and depth of the drilling channel relative to the remaining tooth geometry may be computed as planned parameters. Automatic extraction of image features from the textured 3D (CAD/CAM) data may also be performed in step 1110 to obtain a feature library 1118. A real-time algorithm for registering 2D images from a 2d camera data stream 1120 on the 3D data may be performed and a positional relationship between the drill of the dental instrument and the residual tooth geometry may be computed. Visual feedback about the position and location of the instrument or drill, such as a deviation of the drill from planned drilling parameters, magnified display of the intraoral situation or visual hints/instructions for positioning of the drilling channel concerning angle and depth may then be provided (step 1108) and may be responsive to comparing in step 1106 planned parameter values (such as planned drilling parameter values) to actual parameter values (such as actual drilling parameter values).

Other technical features may be readily apparent to one skilled in the art from the following figures, descriptions, and claims.

Thus, a computer implemented method, system or apparatus, and computer program product are provided in the illustrative embodiments for intelligent dental workflow configurations and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, including but not limited to computer-readable storage devices as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk. C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
providing a dental instrument:
providing a camera fixedly attached to or integrated into the dental instrument;
capturing, by the camera, invisible or poorly visible areas in an oral cavity of a patient by configuring the camera to capture at least an area of operation of a drill of the dental instrument;
comparing two-dimensional (2D) images from the camera with a three-dimensional (3D) model of the patient's jaw to compute a position of the camera or dental instrument in relation to the patient's jaw;
computing a positional relationship between the drill of the dental instrument and the jaw based at least in part on the computed position of the camera or dental instrument and a distance between the drill and the camera or dental instrument;
computing and presenting information about a deviation of one or more actual drilling parameters from one or more corresponding planned drilling parameters to aid a user during drilling.

2. The method of claim 1, wherein the one or more corresponding planned drilling parameters include a drilling angle and a drilling depth.

3. The method of claim 1, further comprising:
displaying the captured invisible or poorly visible areas of the oral cavity and/or displaying the computed position of the drill in relation to the patient's jaw.

4. The method of claim 1, wherein the comparing is performed, based at least in part on matching at least one characteristic feature of teeth present in at least one of the 2D images with a corresponding characteristic feature present in the 3D model,
wherein the matching is performed at runtime based on a search for a correspondence of said at least one of the 2D images and the 3D model.

5. The method of claim 4, wherein responsive to obtaining the correspondence that allows an assignment of said at least one of the 2D images to a jaw region, the positional relationship between the drill of the dental instrument and the jaw is computed.

6. The method of claim 5, wherein the assignment is performed by computing a projection of the 3D model that corresponds to said at least one of the 2D images.

7. The method of claim 5, wherein the an optimization is performed to maximize a similarity between said at least one of the 2D images and the projection of the 3D model to obtain a homography.

8. The method of claim 7, further comprising:
determining an angle of view, orientation, or distance measure of the camera as a camera measurement value based on said homography.

9. The method of claim 8, further comprising:
determining said positional relationship between the drill of the dental instrument and the jaw based at least in part on said camera measurement value.

10. The method of claim 9, further comprising:
determining said positional relationship between the drill of the dental instrument and the jaw based at least in part on dimensions of components of the dental instrument and the camera.

11. The method of claim 4, wherein the at least one characteristic feature is computed on the 3D model and on the 2D images prior to said matching.

12. The method of claim 11, further comprising:
creating a live or a non-real time feature database comprising the at least one characteristic feature for said matching.

13. The method of claim 12, further comprising:
filtering the live or non-real time feature database to reduce a number of available characteristic features.

14. The method of claim 11, wherein the at least on characteristic feature is computed based on a 2D feature extraction algorithm.

15. The method of claim 14, wherein the 2D feature extraction algorithm is a scale-invariant feature transform (SIFT) feature algorithm.

16. The method of claim 1, further comprising:
performing a calibration of the camera based on a pattern plate having a hole for receiving the drill.

17. The method of claim 1, wherein the camera is positioned on the dental instrument outside a sterilizable area of the dental instrument.

18. A computer system comprising:
at least one processor configured to perform the steps of:
providing a dental instrument;
providing a camera fixedly attached to or integrated into the dental instrument;
capturing, by the camera, invisible or poorly visible areas in an oral cavity of a patient by configuring the camera to capture at least an area of operation of a drill of the dental instrument:
comparing two-dimensional (2D) images from the camera with an existing three-dimensional (3D) model of the patient's jaw to compute a position of the camera or dental instrument in relation to the patient's jaw;
computing a positional relationship between the drill of the dental instrument and the jaw based at least in part on the computed position of the camera or dental instrument and a distance between the drill and the camera or dental instrument;
computing and presenting information about a deviation of one or more actual drilling parameters from one or more corresponding planned drilling parameters to aid a user during drilling.

19. A non-transitory computer-readable storage medium storing a program which, when executed by a computer system, causes the computer system to perform a procedure comprising the steps of:
capturing, by a camera fixedly attached to or integrated into the dental instrument, invisible or poorly visible areas in an oral cavity of a patient by configuring the camera to capture at least an area of operation of a drill of the dental instrument;
comparing two-dimensional (2D) images from the camera with a three-dimensional (3D) model of the patient's jaw to compute a position of the camera or dental instrument in relation to the patient's jaw;
computing a positional relationship between the drill of the dental instrument and the jaw based at least in part on the computed position of the camera or dental instrument relative to the jaw and a distance between the drill and the camera or dental instrument;
computing and presenting information about a deviation of one or more actual drilling parameters from one or more corresponding planned drilling parameters to aid a user during drilling.

20. A system comprising:
a dental instrument comprising a drill;
a camera fixedly attached to or integrated into the dental instrument and configured to capture invisible or poorly visible areas of the areas in an oral cavity:
a screen configured to display the captured invisible or poorly visible areas of the areas in an oral cavity;
wherein the screen is further configured to display or present a deviation of one or more actual drilling parameters from one or more corresponding planned drilling parameters to aid a user during drilling

21. The system of claim 20, wherein the screen is configured as an augmented reality (AR) glasses.

22. The system of claim 20, wherein the camera is configured as an intraoral 2D camera.

23. The system of claim 20, wherein the camera is configured as an endoscope.

24. The system of claim 23, wherein the camera is a single use or multiple use camera.

25. The system of claim 23, wherein the endoscope is fixed to the dental instrument by a magnetic holder.

26. The system of claim 23, wherein the camera is an external camera that is fixedly attached to the dental instrument via a corresponding slip-on mount.

27. The system of claim 26, wherein the camera is a single use camera.

28. The system of claim 23, further comprising:
a pattern plate comprising a hole configured to receive a drill of the dental instrument,
wherein the pattern plate is configured to produce patterns for calibrating the camera.

29. The system of claim 23, wherein the camera is fixedly attached to the dental instrument and the dental instrument is configured to receive the camera in a fixed position by locking the camera to the dental instrument via a magnetic lock in a recess of a head of the drill.

30. The system of claim 23, further comprising:
an infrared sensor configured to detect depth information.
